(19) United States
(12) Patent Application Publication
(10) Pub. No.: US 2023/0229945 A1
(43) Pub. Date: Jul. 20, 2023

(54) EXPLAINABLE RESPONSE TIME PREDICTION OF STORAGE ARRAYS DETECTION

(71) Applicant: Dell Products L.P., Round Rock, TX (US)

(72) Inventors: Paulo Abelha Ferreira, Rio de Janeiro (BR); Adriana Bechara Prado, Niterói, RJ (BR)

(21) Appl. No.: 17/648,447

(22) Filed: Jan. 20, 2022

(51) Int. Cl. G06N 5/04; G06N 20/20; G06K 9/62

(52) U.S. Cl. CPC G06N 5/045; G06K 9/6284; G06N 20/20

(57) ABSTRACT

An outlier detection mechanism is disclosed that improves transparency and explainability in machine learning models. The outlier detection mechanism can quantify, at prediction time, how a new observation differs from training observations. The outlier detection mechanism can also provide a way to aggregate outputs from decision trees by weighting the outputs of the decision trees based on their explainability.

### FIELD OF THE INVENTION

Embodiments of the present invention generally relate to machine learning and machine learning models. More particularly, at least some embodiments of the invention relate to systems, hardware, software, computer-readable media, and methods for explaining or understanding outputs generated by machine learning models.

### BACKGROUND

There are many different types of machine learning models and machine learning models are very good at making predictions when properly trained. Machine learning models are, in fact, becoming increasingly capable to tackling real-world problems, particularly when there are a high number of features or attributes to be analyzed.

However, the reasons behind the inferences or predictions are more opaque and the lack of transparency in machine learning models can hinder their adoption. Accountability, decision-making, model management, and the like will be more widely accepted when the rationale behind a model’s output can be explained.

Explainable Artificial Intelligence (XAI) is an area of research whose goal is to understand the rationale behind a model’s outputs. Although the term “explaining”, in the context of machine learning models, is not well defined, the term is generally considered to mean providing transparency into machine learning models. By way of example, transparency may be defined as the opposite of opacity and connotes some sense of understanding the mechanisms by which a model works. Currently, machine learning models are substantially opaque using this definition. However, understanding the reasons behind the outputs of a machine learning model would enable machine learning model users to build better models and have more trust and confidence in the outputs made by their models.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of a decision tree;

FIG. 1B discloses aspects of a random forest machine learning model that includes multiple decision trees;

FIG. 1C discloses aspects of outliers in machine learning;

FIG. 2 discloses aspects of nodes and decisions in a decision making tree;

FIG. 3 discloses aspects of determining a local diversity score (LDS) for each node of a decision tree;

FIG. 4 discloses aspects of a method for explaining the operation of a machine learning model in the context of detecting outliers;

FIG. 5 discloses aspects of outlier detection in machine learning models and explainability;

FIG. 6 discloses aspects of a training data set for a machine learning model;

FIG. 7 discloses aspects of performing explainable outlier detection; and

FIG. 8 discloses aspects of a computing device or a computing system.

### DETAILED DESCRIPTION OF SOME EXAMPLE EMBODIMENTS

Embodiments of the present invention generally relate to machine learning models and to explaining machine learning models. More particularly, at least some embodiments of the invention relate to systems, hardware, software, computer-readable media, and methods for explaining machine learning models using outlier detection. By way of example, explainability allows an output to be explained such that that output is understandable by a person.

Machine learning models can achieve low error rates and embodiments of the invention relate to an outlier detection mechanism to increase the transparency of machine learning models. Embodiments of the invention, in effect, allow outliers to be explained and better understood. Explainability allows the development of machine learning models to be improved, allows errors to be detected in and removed from training data sets, and the like or combination thereof.

Embodiments of the invention are discussed in the context of a random forest, which is an example of a machine learning model. Generally, a random forest includes a plurality of decision trees. Each decision tree typically includes a plurality of nodes and each node represents a decision of some type that may be related to the features of the input. For example, each node may implement an inequality whose output, with regard to a specific feature, is either true or false. However, the decision trees are not the same. In the following disclosure, a data set may include a plurality of observations. In other words, each sample or each input or each datum of a data set is an example of an observation. Each observation may include or be associated with a set of features.

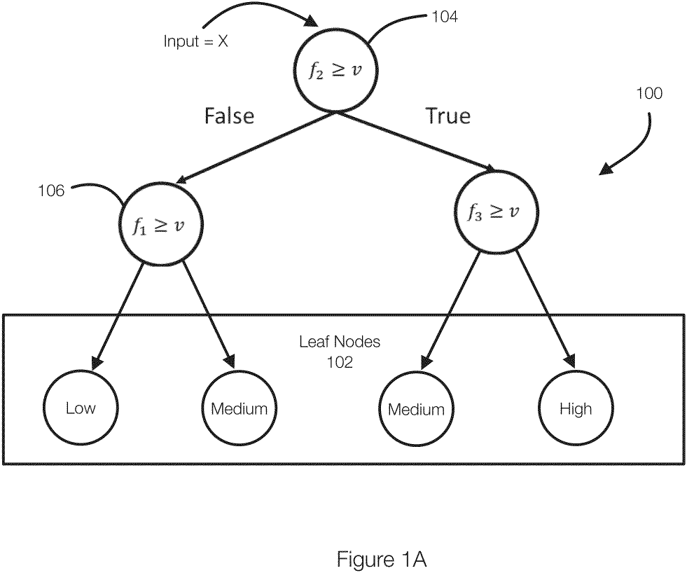

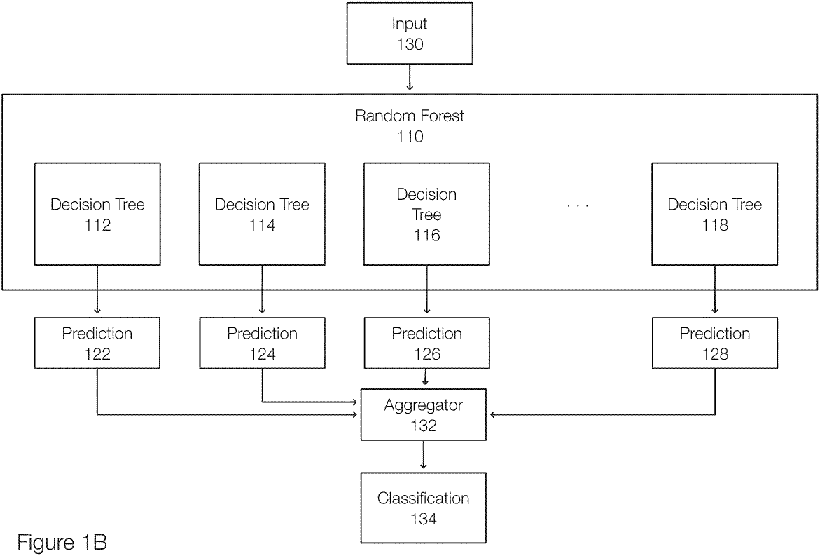

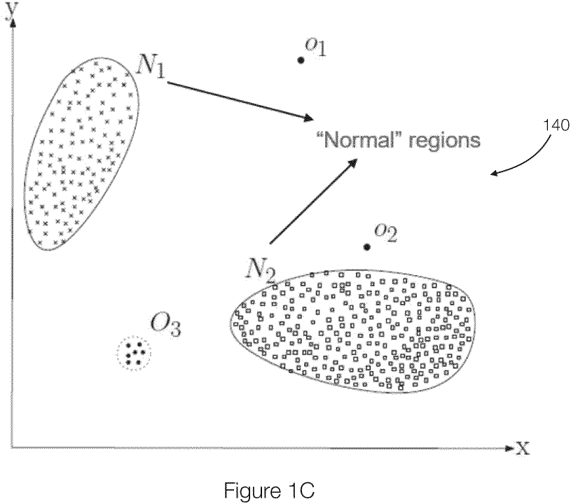

FIG. 1A discloses aspects of a decision tree (hereinafter tree). The tree 100 is part of a random forest that is configured to predict a categorical output. In this example, the output is a class. Thus, each of the observations in the data set can be classified into a specific class. Because each decision tree may generate different classifications for a given observation, the overall output or classification is an aggregation of the outputs of all decision trees.

In the tree 100, the input X, which is an example of an observation, has three attributes or features, which are referenced as f₁, f₂, and f₃. To predict the class of the input X, the input X runs through the tree 100 and is subjected to a series of inequality tests related to the values of the input X’s attributes. This process is performed until the input X reaches a leaf node. Thus, the input X follows a path and may not be processed by all nodes of the tree 100. Each of the leaf nodes 102 is associated with a classification. In this example, the classifications include low, medium and high. The output of the tree 100 thus classifies the input X.

In this example, the top or initial node 104 in the tree 100 tests the value of the attribute f₂. If the comparison is false, the input X follows the left path of the tree 100. If the comparison is true, the input X follows the right path of the tree 100.

In this example, assuming that the comparison at the top node 104 is false, the left path is followed and the next node 106 tests the value of the attribute f₁. If the comparison at the node 106 is false, the input X is classified as “Low” and if the comparison at the node 106 is true, the input X is classified as “Medium”.

If the tree 100 was used in the context of determining whether the size of a storage array is sufficient to support a user’s applications, a classification of “Low” or Medium” may indicate that the storage array is not appropriately sized. As previously stated, however, the classification of an observation is generally based on the output of multiple trees in the random forest.

FIG. 1B illustrates an example of a random forest that includes multiple trees. The random forest 110 includes trees (e.g., thousands or millions of trees) represented by decision trees 112, 114, 116, and 118. Each of the decision trees 112, 114, 116, and 118 is an example of the tree 100. However, the trees 112, 114, 116, and 118 may be configured differently. For example, the top node of the tree 112 may test the attribute f₁ of the input 130 while the top node of the tree 114 may test the attribute f₂. This allows an input to be evaluated in many different manners and ensures that the features are considered in different orders. Further, some nodes may test multiple attributes at the same time. Each of the trees 112, 114, 116, and 118 generate a corresponding prediction 122, 124, 126, and 128. The predictions 122, 124, 126, and 128 are examples of outputs and may be, in one example, classifications.

The output of the random forest 110 or classification 134 of the input 130 may be determined by aggregating, by an aggregator 132, the predictions 122, 124, 126, and 128. The aggregator 132 may generate an average prediction from the outputs of the trees 112, 114, 116, and 118 or use a majority vote mechanism where the predictions 122, 124, 126, and 128 of the trees 112, 114, 116, and 118 each constitute a vote. Thus, the input 130 can be classified into a single classification 134 in this example.

Using multiple trees in the random forest 110 can increase variability and decrease the chance of overfitting the training data. The random forest 110 advantageously requires few hyperparameters (parameters that need to be set a priori and cannot be learned), are efficient to build, do not typically require complex infrastructure for learning, and are efficient to execute when predicting.

Embodiments of the invention improve the explainability or improve the transparency of a random forest by quantifying how different a new observation is in comparison to observations in the training set. More specifically, transparency or explainability is improved by quantifying how different a new observation is with respect to observations that traversed the same path or paths in at least once decision tree of a random forest.

FIG. 1C discloses aspects of outliers. An outlier is often referred to as an anomaly. An outlier, by way of example only, is a data point that is significantly different from the remaining data. The difference may be manifested in the output of the decision tree.

In the graph 140, most data points (predictions) are included in regions N₁ and N₂. The data points o₁, o₂, and the data points in region O₃ are examples of outliers in the graph 140 because they are different from the data points in the regions N₁ and N₂. When a generating process, such as a random forest, behaves unusually, outliers may be created. The outlier may contain useful information about the characteristics of the generating process and/or entities/data set that impact the operation of the random forest. Embodiments of the invention use outliers to quantify how an observation being evaluated compares to training observations and how confident a user may be with respect to the predictions output by the machine learning model.

The outlier detection mechanism disclosed herein is configured to quantify, at prediction time, how different a new observation being evaluated is compared with observations in the training set that traversed the same paths or path in the decision trees or tree of the random forest. The outlier detection method allows the bias or tendencies of specific decision trees to be identified and potentially adjusted. This quantification may be regarded as how confident the user may be with respect to predictions provided by the machine learning model. If an observation is too much of an outlier, confidence in this assertion may be proportional to the amount that the observation is an outlier.

Embodiments of the invention may further be discussed with respect to a smart sizing engine. A smart sizing engine may be implemented as a random forest that is configured to predict the response time of a sized system such as a storage array. In an example use, a goal of the smart sizing engine may be to determine whether a storage array, having a particular size, would have a response time that satisfied the user’s SLA (service level agreement) requirements such as response time and be able to handle the user’s workloads.

For example, a random forest may be used to predict whether storage array has the needed size to support a user’s applications. Sizing is often performed without knowing whether the sized infrastructure will satisfy the response-time requirements of the end user’s applications. The random forest may be used to predict response times for storage arrays based on workloads and system characteristics.

Transparency into the random forest can improve the operation of the random forest, based in part on the outliers, and give the user confidence in the predictions of the random forest. Embodiments of the invention improve transparency in a manner that is related to the way in which an observation traverses the decision trees in a random forest.

In orderto obtain transparency into the model such as the random forest 110, embodiments of the invention may employ a categorical model. An example categorical model is a Bayesian Dirichlet model.

A K-categorical distribution is a discrete probability distribution that represents possible results of a discrete random variable with K states. For instance, the probability distribution over outcomes of a die roll can be represented in terms of a 6-categorical distribution. This is a generalization of the Bernoulli distribution, which represents possible results of a discrete random variable with two states (e.g., flip of a coin). Generalizing from “coin flips” to “K-faced dice rolls” is moving from a Bernoulli distribution to a categorical distribution.

A categorical distribution (the K prefix is omitted), has K-1 parameters, each representing the probability pᵢ for one of the possible outcomes. In this example,

$${\sum }_{i}^{K} {p}_{i} = 1$$

because the parameter vector p represents the probabilities for all categories. Further, only K-1 known parameters need to be specified because an unknown parameter can always be inferred through

$${p}_{j} = 1 - {\sum }_{i}^{K} {p}_{i ⋅}$$

The Bayesian probabilistic framework allows beliefs to be continuously updated. More concretely, imagine a 6-faced die that is believed to be fair. However, the fairness is not certain. Representing a uniform probability over all faces of the die does not represent the uncertainty over the belief of fairness. In other words, out of all of the possible biases over all of the faces, there is uncertainty regarding what is the belief over each face and what is the belief over all possible biased dice. This is an example where a prior probability allows an explicit belief to be put over another probability distribution. The update of such a belief is represented, by way of example, using a Bayesian update such as P(p; a′)∝ P(d; pᵢ ... p_{K-1})P(p; α).

The Bayesian update includes the likelihood distribution P(d; pᵢ ... p_{K-1}) for the random variable representing the face d of the die, the prior distribution (prior belief) P(p;a) for the belief over the parameters p for the bias of the die, and the posterior distribution for our updated belief over the parameters p for the bias of the die. Whenever a posterior distribution is in the same family as the prior distribution, this is called a conjugate prior of the likelihood.

The Dirichlet distribution is the conjugate prior for the categorical (and multinomial) distribution. The Dirichlet distribution is distributed over the K-1 dimensions and guarantees that any observation vector of parameters sums to 1. In other words, the Dirichlet allows a belief to be represented over the parameters of a K-categorical distribution. In the example above, P(p;a′) and P(p;α) are both Dirichlet distributions and are parameterized by a parameter vector α.

Thus, the K-categorial distribution allows a belief to be represented over a random variable that can take K distinct values. The Dirichlet distribution allows a belief to be represented over the bias of a categorical distribution. The Bayesian framework allows the belief to be updated, starting with a likelihood (e.g., distribution for a die); a prior (e.g., belief over the bias of the die); to arrive at a posterior (e.g., a new belief over the bias for a die).

In one example, the decision trees of a random forest may be trained with a set of observations O = {o₁, o₂, ... oₙ}. Each observation in the training data set O may include or be associated with a set of features F = {f₁, f₂, ... fₘ}. A diversity score (DS) can be determined for each new observation (not part of the training set O) that represents how much of an outlier the new observation is compared to the observations of the training set. The DS may be normalized to be between 0 and 1.

To predict the output (e.g., a performance score) of a new observation yᵢ (not part of the training dataset O), the new observation yᵢ is run through a series of inequality tests in a decision tree until it reaches a leaf of the decision tree. As previously stated, this leaf carries the predicted value (e.g., an output such as a classification or other value depending on the tree).

In order to bring transparency to decision trees and give users the ability to evaluate how different new observations are in comparison to the observations in the training data set, embodiments of the invention enrich the training stage with new functionalities and compute a diversity score for every new observation for which an output is predicted.

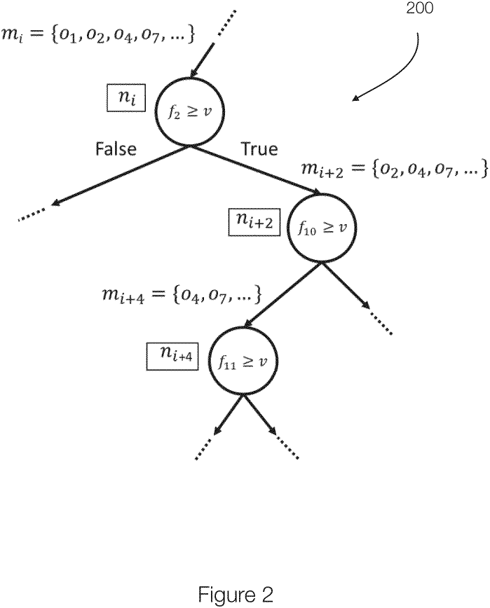

FIG. 2 discloses aspects of enriching a decision tree. When training a decision tree (or decision trees in a random forest), each node of the tree is mapped to observations that reached or traversed that node. Thus, each node is mapped to a set of observations that is a subset of the entire set of observations. The set of observations mapped to each node includes the training observations the came from one of the paths of the father node.

FIG. 2 further illustrates a portion of a tree 200. In the tree 200, the node nᵢ is associated with a set of training observations mᵢ. Thus, the node nᵢ₊₂ is associated with a set of training observations mᵢ₊₂ and the node nᵢ₊₄ is associated with a set of training observations mᵢ₊₄. Nodes of the tree 200 not illustrated are each similarly associated with a set of training observations.

By way of further example, the set of training observations mᵢ₊₂ = {o₂, o₄, o₇, ...} is mapped to the node nᵢ₊₂. In this example, all of the observations in mᵢ₊₂ met the inequality text f₂ ≥ vassociated with the father node nᵢ.

Because each node nᵢ the tree 200 is associated with an inequality test over a feature fⱼ, a probability distribution can be determined for each node nᵢ the tree 200 over the values o:fⱼ in mᵢ. These probability distributions, one for each node in the tree 200, can be constructed via a probability function fitting method such as Gaussian fitting or Gaussian Mixture fitting. Once the probability distributions are constructed, the parameters can be stored. By way of example only, for a Gaussian distribution, only the mean and variance are stored as a pair of parameters. Thus, each node of the tree 200 is associated with one pair of parameters.

Once the training stage is enriched with these functionalities or parameters, a diversity score DS can be determined to every new observation (not in the training set of observations) that is run through the trained decision tree. This may be performed for each tree in the random forest.

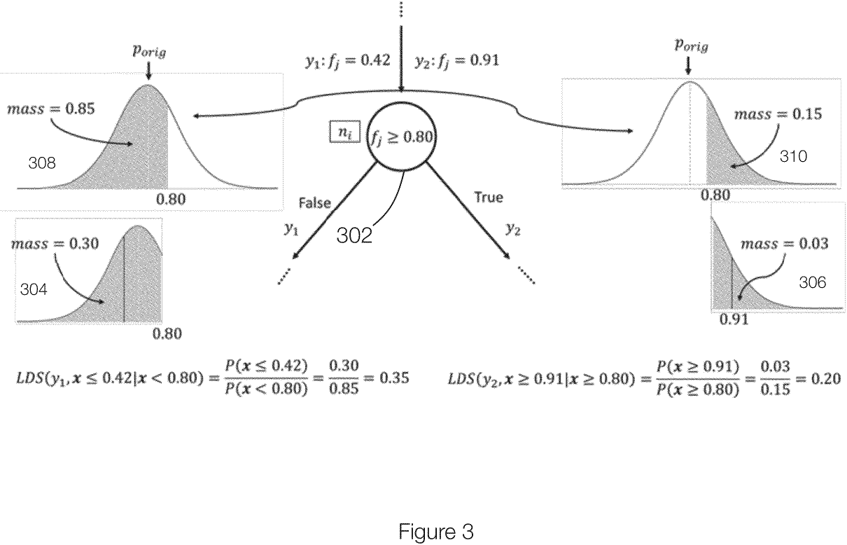

FIG. 3 discloses aspects of assigning a diversity score to each new observation that is run through a decision tree. FIG. 3 illustrates a node nᵢ302 of a decision tree and more specifically illustrates aspects of assigning a local diversity score LDS for each new observation at the node 302. In this example, the node 302 is traversed by new observations y₁ and y₂. The node 302 includes or is associated with an inequality related to an attribute fⱼ and asks whether fⱼ is greater than or equal to 0.80. The values of the new observations are as follows: y₁:fⱼ = 0.42 and y₂:fⱼ = 0.91.

At the node 302, the inequality for y₁ is false and the inequality for y₂ is true. The probability distribution calculated for the node 302 during the training stage is P_{orig}.

The cut-off point for the node 302 is 0.80 and the cut-off point defines two different masses at the node 302. The mass 308 (equal to an integral in one example) up to the cut-off point is 0.85 and the mass 310 after the cut-off point is 0.15. These two masses sum to 1.

More specifically, the mass 308 associated with observations that followed the left path (False) of the node 302 during the training stage is 0.85 and the mass 310 associated with the observations that followed the right path of the node 302 during the training stage is 0.15.

In one example, the mass for a given interval is determined as a definite integral of the probability density function over the interval. FIG. 3 further illustrates the masses associated with the new observations y₁ and y₂. The value of y₁ is 0.42 and, based on the inequality of the node 302, follows the left path. In order to calculate the LDS related to y₁ (LDS(y₁nᵢ)), a determination is made regarding the mass that is to the left of 0.42 as illustrated in the graph 304. In this example, the mass associated with y₁ is 0.30. The LDS can be determined by normalizing the mass associated with y₁. As a

$$L D S \left({y}_{1} , {n}_{i}\right) = \frac{0.30}{0.85} = 0.35.$$

Using a similar analysis for y₂, the LDS for y₂ is, as illustrated in the graph 306:

$$L D S \left({y}_{2} , {n}_{i}\right) = \frac{0.03}{0.15} = 0.20.$$

When a new observation runs through a decision tree, the observation follows a specific path starting from the root node. Thus, the observation passes through a subset of the decision tree’s nodes, such as {n_{1,} ..., nₚ}. An LDS score is determined for each node in the subset of nodes of the tree traversed by the new observation. Thus, the new observation is associated with a set of LDS scores. The set of LDS scores can be aggregated into a single diversity score DS(y) of the new observation y.

One example of an aggregated score DS(y) is a mean of the LDS scores. This may be represented as follows:

$$D S \left(y\right) = \frac{1}{P} {\sum }_{i = 1}^{P} L D S \left(y , {n}_{i}\right) .$$

Embodiments of the invention are not limited to the mean. In another example, a log-likelihood mean may be used such as:

$$D S \left(y\right) = \frac{1}{P} {\prod }_{i = 1}^{P} L D S \left(y , {n}_{i}\right) .$$

By way of example, the LDS scores are aggregated into a single DS score or value for each decision tree. Lower DS scores suggest that the new observation is more diverse with respect to the observations that trained the tree. In other words, the lower the DS score, the greater the diversity of the new observations. Further, lower DS scores may also be associated with lower confidence in the prediction. Thus, the lower the DS score, the lower the confidence in the prediction made by the decision tree model.

DS scores can be determined for each new observation in a set of new observations. This results in an array of diversity scores. The distribution of the array of diversity score can be charted to analyze the diversity of a set of new observations compared to the diversity of a single new observation.

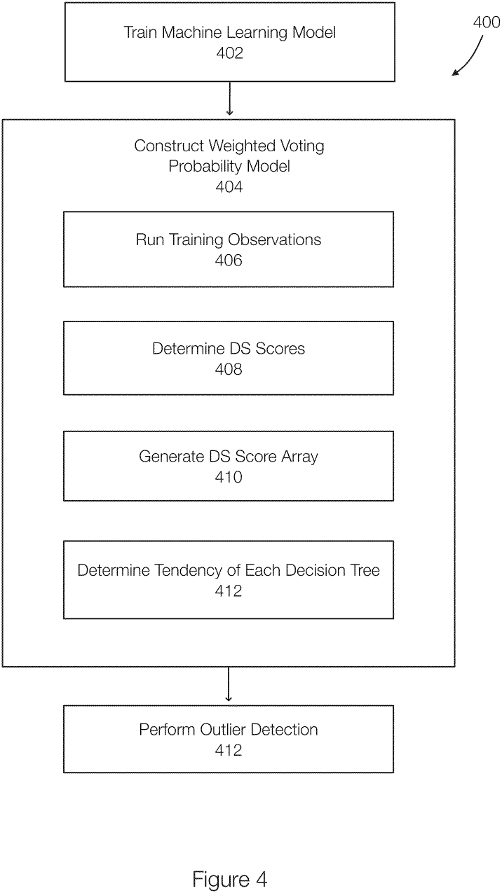

FIG. 4 discloses aspects of explaining a machine learning model. In one example, transparency into the machine learning model is achieved with an outlier detection technique that quantifies, at prediction time, how different a new observation being evaluated is compared with observations in the training set that traversed the same paths in the machine learning model. Embodiments of the invention may operate in conjunction with other explainability techniques.

Embodiments of the invention may be applied to systems where historical data is available. The data may be relevant to a particular problem. As previously discussed, the smart sizing engine is configured to predict the response time of a sized system for a workload.

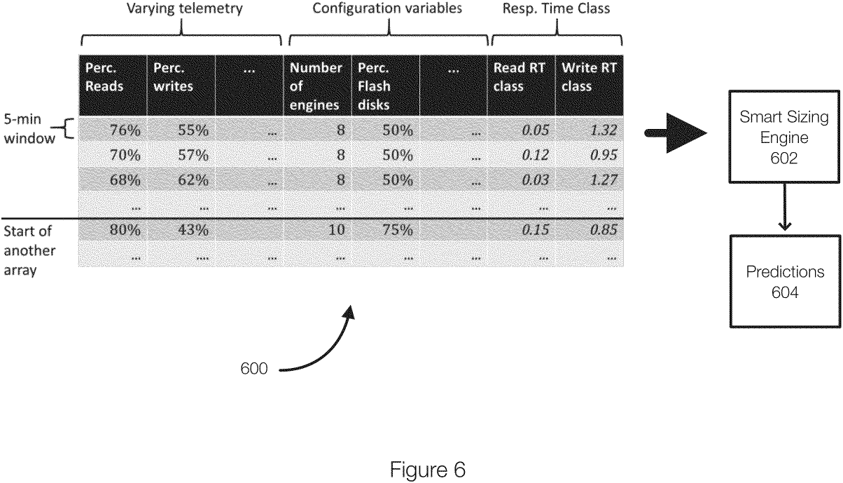

In this example of the smart sizing engine, historical telemetry data is used as the training set. Initially, the training data set is cleaned prior to training the random forest. Cleaning the training data may include removing unnecessary telemetry variables (features) and unnecessary telemetry observations. The set of training observations should include observations with different attributes along with the target variable. FIG. 6 illustrates a dataset 600 of observations that may be used for training the smart sizing engine 602 to generate predictions 604, which may include classifications of the observations. The data set 600 includes different data collections where each collection is a set of snapshots of a system’s operation. The data set 600 includes data related to telemetry, configuration variables, and response times.

Embodiments of the invention may enrich the random forest (e.g., the smart sizing engine 602) in a manner that allows LDS and DS scores to be determined for each new observation. Using these scores, embodiments of the invention can determine, at prediction time, how different a new observation is related to observations in the training data set that traversed the same paths in the decision trees of the random forest. This provides explainability that allows the predictions or results to be evaluated and understood and can aid in identifying inconsistencies in the input data or the input observations.

Conventionally, a random forest that includes deep trees can be opaque because of the difficulty in understanding which paths were traversed by the new observations. Embodiments of the invention bring transparency to the random forest and improve trust and confidence in the recommendations.

FIG. 4 discloses aspects of performing outlier detection and improving explainability and transparency of a machine learning model such as a random forest. The ability to identify outliers, in one example, allows decision trees that produce outliers to be weighted differently. Stated differently, if a decision tree that produces a low number of outliers during training has a high DS for a new observations, the decision tree should have a high weight or higher weight compared to decision trees that may produce more outliers or that generate a lower DS score for a new observation.

The elements of the method 400 are described in a certain order. However, the elements are not limited to this order. Further, some of the elements may be performed at least partially concurrently or in an overlapping manner.

In the method 400, the machine learning model or random forest is trained 402. Next, a weighted voting probability model is constructed 404. This includes running 406 the training observations through the random forest. For every decision tree in the random forest, a DS score is determined 408. The DS scores are determined by determining LDS scores for each of the nodes in the trees.

Next, a score array is generated 410. The score array is an array that identifies, for each of the N observations, the tree that generated or is associated with the lowest DS score.

More specifically, the decision trees in the random forest are indexed. Thus, if the random forest has 1000 decision trees, the trees are indexed as tree[1] -tree[1000]. For each training observation, the index of the decision tree that had the lowest DS score is stored in the score array. More specifically, if there are N training observations and M decision trees, this results in a score array n̅ with N elements. Each element i of the array storing the index (from 1.. M) of the decision tree for which i had the lowest DS score. Each element of this array n̅ may be interpreted as a sample of one M-categorical random variable. This would be like rolling a die with M faces N times.

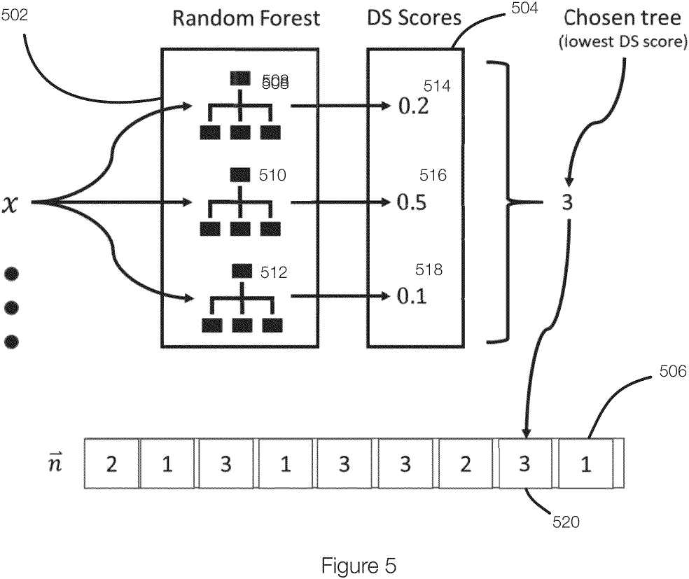

This is further illustrated in FIG. 5, which depicts aspects of selecting the decision tree with the lowest score for a given input or observation. FIG. 5 illustrates an input or observation x that is input to the trees of a random forest 502. Each of the trees in the random forest 502 is associated with a DS score 504 for the observation x. For the observation x, the tree 508 generated a DS score 514 of 0.2, the tree 510 generated a DS score 516 of 0.5, and the tree 512 generated a DS score of 0.1. Of these DS scores 504, the tree 512 (whose index is 3) generated the lowest score 518 of 0.1. Thus, the tree 512 is selected and the index of the tree 512 (which is 3) is stored in the array n̅506 at the appropriate entry 520 in the array 506.

Referring back to FIG. 4, generating 410 the score array results, by way of example only, in an array that identifies the decision tree that produced the lowest DS score for each of the N training observations.

After generating 410 the score array, the tendency of each decision tree can be determined 412. More specifically, a Bayesian Dirichlet categorical model can be fit to the array to learn or determine the tendency of each tree to generate high DS scores. In other words, a probability model can be built to indicate a bias for each decision tree. In this example of a Bayesian model, there is one random variable T:{1,2..M} → R. In this model, M is the number of trees, with T~Cat_{M}(T;p̅). In this example, T comes from a categorical distribution of an M-categorical variable. The parameters p̅ of the categorical distribution are assumed to come from a conjugate Dirichlet Dir(p̅; a̅), which is parameterized by a parameter vector a̅.

The Bayesian update is given by:

$$D i r \left(\vec{p} ; {\vec{α}}^{′}\right) ∝ C a {t}_{M} \left(T \left|\vec{p}\right)\right) D i r \left(\vec{p} ; \vec{α}\right) .$$

The posterior density is also a Dirichlet distribution with

$${\vec{α}}^{′} ∈ {ℝ}^{M}$$

. The parameters of the posterior Dirishlet distribution can be obtained from a combination of prior parameters with the count of occurrences of each decision tree through:

$${{\vec{α}}^{′}}_{m} = {\vec{α}}_{m} + {\sum }_{j = 1}^{N} 1 \left\{{\vec{n}}_{j} = m\right\} .$$

In this example, 1{n̅ⱼ = m} is an indicator function to count the number of occurrences of each outcome {1,2.. M} (index of the decision trees) in the array n̅. The updated Dirichlet parameters a̅′ can be used to obtain the mode of the Dirichlet. The mode can be used as the new bias vector t̅ for the random forest, where:

$${\vec{t}}_{m} = \frac{{{\vec{α}}^{′}}_{m} - 1}{\left({\sum }_{i}^{M} {{α}^{′}}_{i}\right) - M} .$$

For the first training of the random forest, a uniform prior for Dirichlet of a̅ₘ = 1 + ε is selected. In this case, all elements of a̅ are 1 and, to ensure computability of the mode, 0 < ε « 1.

With this information, the weight vector w is constructed as a complement of t. In this example, w̅ = (max(t̅ᵢ) + 1) - t̅.

This allows higher weights to be given to decision trees where the training observations behaved less as outliers. If a decision tree that produces a low number of outliers during training has a high DS score for a new observation, that tree should have a higher weight.

Next, outlier detection is performed 412. More specifically and by way of example, outlier detection can be performed in a separate set of new observations that are not part of the training set. Once the set of N new observations is obtained, the set of new observations are run through the random forest and DS scores are collected for each of the M trees, which will lead to an N x M matric D storing, for each new observation, the DS score determined for each decision tree. In order to arrive at a single score per new observation, the array of scores s̅ is calculated as s̅ = D • w̅.

More specifically, each posterior Dirichlet component is used as a weight for each decision tree. In this example, the matrix-vector multiplication will multiply each row of D (DS score obtained for each decision tree for a single observation) by the weight vector w yielding a vector s with the final score for all new observations. The lower the final score of the new observation, the more the new observation is an outlier. Comparing these relative final scores allow decision trees or new observations to be identified as more or less of an outlier. Thus, the lower the score, the more diverse the observation is with respect to the observations used to train the model. The score may also indicate how confident the model is with respect to the prediction. As a result, if an observation or sample is too much of an outlier, the confidence in the prediction should be proportional to the extent to which the observation is an outlier.

As more training observations are collected, the random forest can be retrained. This allows the Bayesian model to be retrained using the previous posterior as prior to obtain new posterior Dirichlet parameters a′ to be used to obtain the mode as new weights. The Dirichlet probability mode can also be used as a representation of the bias of each tree in the random forest.

By adjusting the weights in this manner, a modular approach for outlier voting in random forest models is provided. Returning to the smart sizing engine, embodiments of the invention can provide some transparency regarding the response time prediction in storage arrays. Further, additional training allows for Bayesian updates to obtain new voting weights for each decision tree in the random forest.

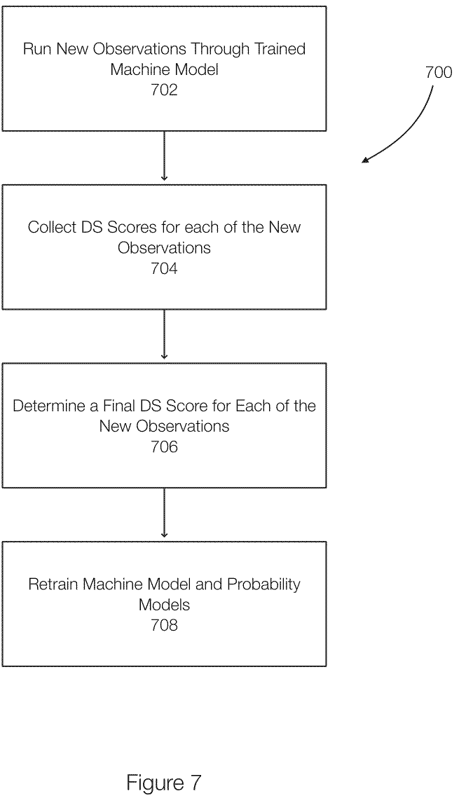

FIG. 7 discloses aspects of a method for performing outlier detection. In the method 700, new observations are run 702 through a trained model, such as a trained random forest. As the new observations are run through the trained model, DS scores are collected for the new observations from each of the decision trees.

Next, a final DS score is determined 706 for each of the new observations. The final DS score is determined using a weighted voting that accounts for biases of the individual trees in the machine model. Optionally or as necessary, the machine model is retrained 708. This may also include retraining a Bayesian model to obtain new posterior Dirichlet parameters to obtain the mode as new weights to be used in the voting.

A weighted voting model allows a final score to be determined. This allows the DS scores from the individual trees to be aggregated in a manner that accounts for their corresponding weights. Further, by providing weights to each decision tree, embodiments of the invention can be integrated or combined with other explainability measures that may be used on the model.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, IO replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, virtual machines (VM), or containers.

Particularly, devices in the operating environment may take the form of software, physical machines, VMs, containers, or any combination of these, though no particular device implementation or configuration is required for any embodiment.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as observation, document, file, segment, block, or object may be used by way of example, the principles of the disclosure are not limited to any particular form of representing and storing data or other information. Rather, such principles are equally applicable to any object capable of representing information.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising: running training observations through decision trees of a random forest, determining a diversity score from each of the decision trees for each of the training observations, generating a diversity array, wherein each entry in the diversity array includes an index of a decision tree that generated a lowest diversity score for a corresponding training observation, determining a tendency of each decision tree in the random forest based on the diversity array, and weighting each of the decision trees based on the tendencies of the decision trees.

Embodiment 2. The method of embodiment 1, further comprising training the decision trees of the random forest with the training observations.

Embodiment 3. The method of embodiment 1 and/or 2, further comprising enriching each of the decision trees such that each node in each of the decision trees is associated with a set of training observations that traversed the corresponding node.

Embodiment 4. The method of embodiment 1, 2, and/or 3, further comprising determining the tendency of each decision tree by building a categorical model configured to identify a bias of each of the decision trees.

Embodiment 5. The method of embodiment 1, 2, 3, and/or 4, further comprising constructing a weight vector and applying the weight vector to the decision trees.

Embodiment 6. The method of embodiment 1, 2, 3, 4, and/or 5, wherein the weight vector is configured to give a higher weight to decision trees associated with training observations that behaved lass as outliers compared to other decision trees in the random forest.

Embodiment 7. The method of embodiment 1, 2, 3, 4, 5, and/or 6, further comprising performing outlier detection on new observations that are not included in the training observations.

Embodiment 8. The method of embodiment 1, 2, 3, 4, 5, 6, and/or 7, further comprising detecting outliers at a time of prediction.

Embodiment 9. The method of embodiment 1, 2, 3, 4, 5, 6, 7, and/or 8, further comprising generating a final diversity score for each of the new observations by aggregating weighted diversity scores associated with the decision trees.

Embodiment 10. The method of embodiment 1, 2, 3, 4, 5, 6, 7, 8, and/or 9, wherein the categorical model is a Bayesian Dirichlet categorical model, the method comprising updating the Bayesian Dirichlet categorical model.

Embodiment 11. A method for performing any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

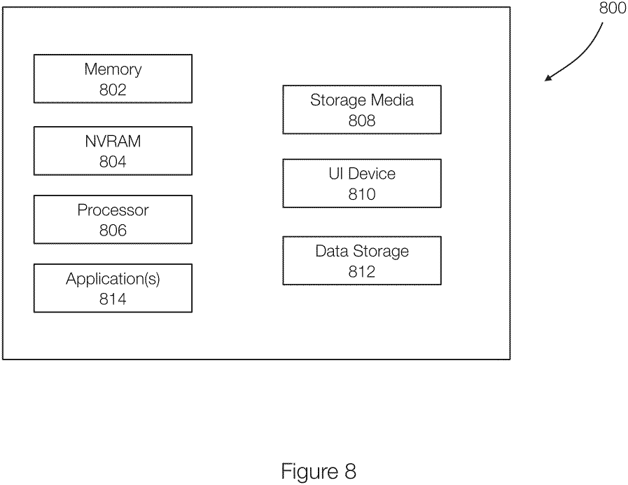

With reference briefly now to FIG. 8, any one or more of the entities disclosed, or implied, by the Figures and/or elsewhere herein, may take the form of, or include, or be implemented on, or hosted by, a physical computing device, one example of which is denoted at 800. The device 800 may also be viewed as a computing system. As well, where any of the aforementioned elements comprise or consist of a virtual machine (VM) or container, that VM or container may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
running training observations through decision trees of a random forest;
determining a diversity score from each of the decision trees for each of the training observations;
generating a diversity array, wherein each entry in the diversity array includes an index of a decision tree that generated a lowest diversity score for a corresponding training observation;
determining a tendency of each decision tree in the random forest based on the diversity array; and
weighting each of the decision trees based on the tendencies of the decision trees.

2. The method of claim 1, further comprising training the decision trees of the random forest with the training observations.

3. The method of claim 1, further comprising enriching each of the decision trees such that each node in each of the decision trees is associated with a set of training observations that traversed the corresponding node.

4. The method of claim 1, further comprising determining the tendency of each decision tree by building a categorical model configured to identify a bias of each of the decision trees.

5. The method of claim 4, wherein the categorical model is a Bayesian Dirichlet categorical model, the method comprising updating the Bayesian Dirichlet categorical model.

6. The method of claim 4, further comprising constructing a weight vector and applying the weight vector to the decision trees.

7. The method of claim 6, wherein the weight vector is configured to give a higher weight to decision trees associated with training observations that behaved less as outliers compared to other decision trees in the random forest.

8. The method of claim 1, further comprising performing outlier detection on new observations that are not included in the training observations.

9. The method of claim 8, further comprising detecting outliers at a time of prediction.

10. The method of claim 8, further comprising generating a final diversity score for each of the new observations by aggregating weighted diversity scores associated with the decision trees.

11. A non-transitory storage medium having stored therein instructions that are executable by one or more hardware processors to perform operations comprising:
running training observations through decision trees of a random forest;
determining a diversity score from each of the decision trees for each of the training observations;
generating a diversity array, wherein each entry in the diversity array includes an index of a decision tree that generated a lowest diversity score for a corresponding training observation;
determining a tendency of each decision tree in the random forest based on the diversity array; and
weighting each of the decision trees based on the tendencies of the decision trees.

12. The non-transitory storage medium of claim 11, further comprising training the decision trees of the random forest with the training observations.

13. The non-transitory storage medium of claim 11, further comprising enriching each of the decision trees such that each node in each of the decision trees is associated with a set of training observations that traversed the corresponding node.

14. The non-transitory storage medium of claim 11, further comprising determining the tendency of each decision tree by building a categorical model configured to identify a bias of each of the decision trees.

15. The non-transitory storage medium of claim 14, further comprising constructing a weight vector and applying the weight vector to the decision trees.

16. The non-transitory storage medium of claim 15, wherein the weight vector is configured to give a higher weight to decision trees associated with training observations that behaved lass as outliers compared to other decision trees in the random forest.

17. The non-transitory storage medium of claim 11, further comprising performing outlier detection on new observations that are not included in the training observations.

18. The non-transitory storage medium of claim 17, further comprising detecting outliers at a time of prediction.

19. The non-transitory storage medium of claim 17, further comprising generating a final diversity score for each of the new observations by aggregating weighted diversity scores associated with the decision trees.

20. The non-transitory storage medium of claim 14, wherein the categorical model is a Bayesian Dirichlet categorical model, the method comprising performing continuous learning using new observations.
